(19) United States
(12) Patent Application Publication
(10) Pub. No.: US 2023/0272983 A1
(43) Pub. Date: Aug. 31, 2023

(54) TEMPERATURE CONTROL DEVICE, IN PARTICULAR A COOLING DEVICE FOR A MOTOR VEHICLE

(71) Applicant: VALEO SYSTEMES THERMIQUES, La Verriere (FR)

(72) Inventors: Aurelie BELLENFANT, La Verriere (FR); Juan-Carlos BATISTA, La Verriere (FR); Marc HERRY, La Verriere (FR); Fethy DJALLAL, La Verriere (FR); Julien VERON, La Verriere (FR)

(73) Assignee: VALEO SYSTEMES THERMIQUES, La Verriere (FR)

(21) Appl. No.: 18/006,935

(22) PCT Filed: Jul. 12, 2021
(86) PCT No.: PCT/EP2021/069359

§ 371 Date: Jan. 26, 2023

(30) Foreign Application Priority Data
Jul. 27, 2020 (FR) FR2007910

(51) Int. Cl. F28F 3/02; H01M 10/6556; H01M 10/613

(52) U.S. Cl. CPC F28F 3/025; H01M 10/6556; H01M 10/613

(57) ABSTRACT

The invention relates to a temperature control device, in particular a cooling device, for an electrical component that is capable of releasing heat during its operation, in particular for an electrical energy storage module. The device has a first outer plate and a second outer plate, as well as a central member arranged between the two outer plates. The central member includes reliefs arranged in order to form, with the outer plates, at least two layers of circulation channels for a heat-transfer fluid. The layers are located on either side of the central member and have the same heat-transfer fluid circulation direction.

### TECHNICAL FIELD

The present invention relates to a thermal regulation device, in particular a cooling device, in particular for an electrical component liable to give off heat during its operation, in particular a device for cooling at least one battery or battery cells of a motor vehicle

### BACKGROUND OF THE INVENTION

Vehicle batteries, in particular for electric vehicles or hybrid vehicles, should as much as possible be maintained at the desired temperature, which is why so-called vehicle battery cooling devices are used. These cooling devices can comprise cooling plates through which a cooling liquid circulates. The cooling plates are installed, as far as possible without gaps, on the outer side of the batteries in order to dissipate heat or else to heat the battery. Cooling devices are known in which the cooling plate is made up of two plate parts that are normally directly fastened to one another. In this case, the first plate part is preferably flat, and the second plate part is preferably a stamped or deformed sheet of metal that has meandering depressions. Said depressions are closed by the flat plate part that is fixed to the stamped plate part, such that refrigerant ducts are formed. Patent EP 2 828 922 B1 describes such a device.

Mention can also be made of patent application US2015144314, which describes a battery cooling device with a fluid connection flange.

### SUMMARY OF THE INVENTION

The invention aims to improve this type of device.

In the present invention, the heat-transfer fluid, which is in particular a refrigerant fluid, is in particular a fluid chosen from the following refrigerant fluids R134a, R1234yf or R744.

One subject of the invention is thus a thermal regulation device, in particular a cooling device, for an electrical component liable to give off heat during its operation, in particular for an electrical energy storage module, this device having a first external plate and a second external plate, and also a central member disposed between the two external plates, this central member comprising reliefs arranged to form, with the external plates, at least two layers of circulation channels for a heat-transfer fluid, these layers being on either side of the central member, these two layers having the same heat-transfer fluid circulation direction.

According to one aspect of the invention, the external plates each have a face arranged to be in thermal contact respectively with one of the components to be cooled.

Thus, the heat exchanges between the thermal regulation device and the component to be cooled, in particular when this direct contact is over a relatively large surface area, can be optimal.

According to one aspect of the invention, the reliefs on the central member that form the channels have ribs.

According to one aspect of the invention, the central member has at least one part arranged to contribute to the formation of a fluid inlet or outlet zone of the thermal regulation device, this zone being in particular dedicated to a fluid circuit that groups together a plurality of thermal regulation devices that are connected to each other so as to cool a battery pack.

According to one aspect of the invention, the central member, in particular by means of the reliefs, is arranged to ensure sufficient mechanical strength to withstand the mechanical stresses associated with the use of the heat-transfer fluid, in particular of a refrigerant. The mechanical strength makes it possible in particular to ensure sealing at 15 bars of pressure of the refrigerant, and resistance to bursting at a pressure of 54 bars of the refrigerant.

According to one aspect of the invention, the thermal regulation device is also arranged to ensure limited deformation under use pressure.

According to one aspect of the invention, the central member is also arranged to ensure satisfactory thermal performance, by virtue of a maximum passage cross section to limit the refrigerant pressure drops along the circuit, but also a maximum wetted surface area to promote heat exchange with the component to be cooled.

According to one aspect of the invention, the central member has a sheet with corrugations that form the reliefs.

According one aspect of the invention, these corrugations extend from one edge of the sheet to the other.

According to one aspect of the invention, these reliefs of the sheet are formed by forming or stamping.

According to one aspect of the invention, this sheet has a substantially rectangular shape.

According to one aspect of the invention, this sheet is made of aluminum.

As a variant, the central member has a plate.

According to one aspect of the invention, the reliefs on the plate are formed by stamping.

According to one aspect of the invention, the plate is made of aluminum.

According to one aspect of the invention, the plate forming the central member has at least one hole, preferably a plurality of holes, for passage of heat-transfer fluid over the two layers, this or these holes thus communicating with the two layers.

According to one aspect of the invention, the central member has at least one fluid separating partition for creating heat-transfer fluid paths within the thermal regulation device.

According to one aspect of the invention, fluid inlet/outlet zones, also called header tanks, in the thermal regulation device and partitions making it possible to create the refrigerant circulation within this thermal regulation device are preferentially created on the central member in order to limit the number of components. The routing within each thermal regulation device ensures uniformity of temperature between each battery cell of one and the same module.

According to one aspect of the invention, each thermal regulation device is arranged to cool two battery modules placed against each of these faces.

The invention makes it possible to ensure good uniformity between the two faces of the thermal regulation device, in other words between the two external plates.

According to one aspect of the invention, these inlet or outlet zones are placed in connection with a connection flange placed on one of the external plates by means of orifice thus allowing the fluidic connection of the various components.

According to one aspect of the invention, the thermal regulation device is arranged to be disposed substantially vertically, between two components to be cooled.

According to one aspect of the invention, the thermal regulation device is arranged to be fastened to the component to be cooled by screwing or by adhesive bonding. Other fastening methods can of course be envisaged.

According to one aspect of the invention, the brazing of the external plates and of the central member relative to one another makes it possible to create two fluid circulation layers along the height/thickness of the device.

According to one aspect of the invention, these two layers have the same circulation direction in order to meet the criteria of uniformity of temperature between the various components to be cooled.

The invention makes it possible to simultaneously supply the two layers with one and the same distribution tank.

When the central member comprises the corrugated sheet, this member can be shorter than the external plates in order to allow the creation of two distribution tanks on either side of the central member and facing the connection flanges in order to allow the fluid to supply both layers at the same time, once it has entered the exchanger via said flange.

According to one aspect of the invention, patterns, for example hollows or protrusions, are created on at least one of the external plates at these distribution tanks in order to prevent the deformation of the latter under the pressure of the fluid.

In order to create two opposite circulation directions across the width of the thermal regulation device, a stamped shape can be created on one of the external plates facing the connection flanges, and also a specific shape on the central member in order to create two groups of channels in which the fluid can circulate in an opposite direction.

According to one aspect of the invention, the central member comprises holes in order to allow the fluid, once it has entered via the connection flange, to be able to circulate or recirculate over the two layers. In order to create two opposite circulation directions across the width of the device, a stamped shape is created on one of the external plates facing the connection flanges.

Another subject of the invention is a system having battery cells to be cooled and at least one thermal regulation device as claimed in one of the preceding claims, for cooling these cells.

The system has a direct cooling loop to which the thermal regulation device is connected.

Another subject of the invention is a system having an electrical component liable to give off heat during its operation, in particular for an electrical energy storage module, and a cooling device described above, arranged to cool the component, this component or battery being in thermal contact with the upper plate of the cooling device.

### BRIEF DESCRIPTION OF DRAWINGS

Further features and advantages of the invention will become more clearly apparent upon reading the following description, which is given by way of illustrative and non-limiting example, and the appended drawings, in which:

FIG. 1 schematically and partially illustrates a device according to one example of the invention,

FIG. 2 schematically and partially illustrates the device in FIG. 1 in a different view,

FIG. 3 schematically and partially illustrates the device in FIG. 1 in a different view so as to reveal the fluid paths,

FIG. 4 schematically and partially illustrates a device according to another example of the invention, and

FIG. 5 schematically and partially illustrates the device in FIG. 4 in a different view.

### DETAILED DESCRIPTION OF THE INVENTION

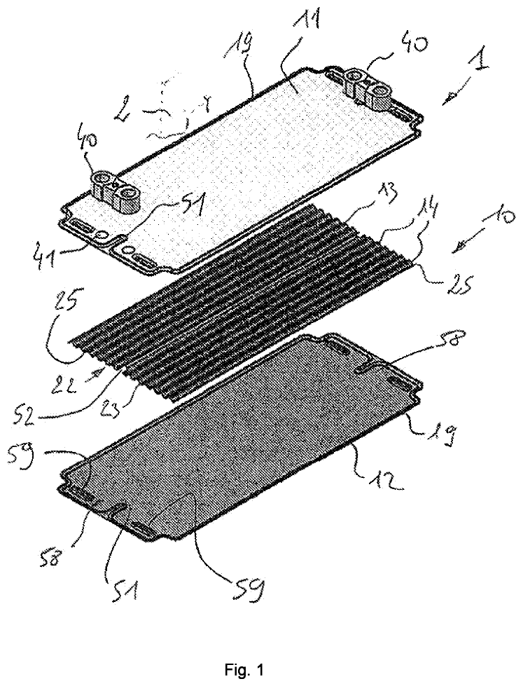

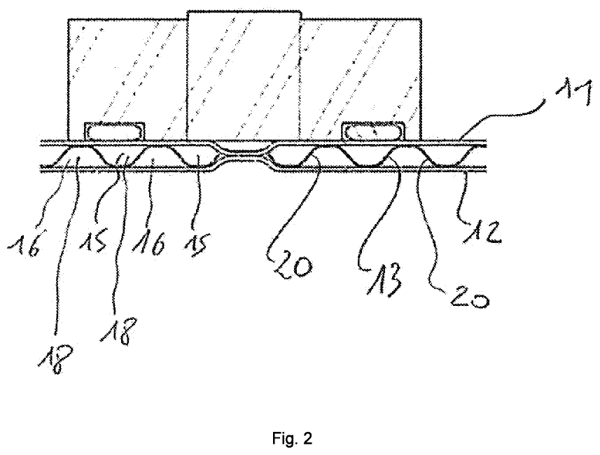

FIG. 1 and FIG. 2 depict a system 1 having a set of battery cells 2 to be cooled, for example rowed in one row or two or more rows, and a thermal regulation device 10 arranged to cool the battery cells 2. The application is in this case for a motor vehicle.

The thermal regulation device 10 operates with a refrigerant fluid, in particular a fluid chosen from the following refrigerant fluids R134a, R1234yf or R744.

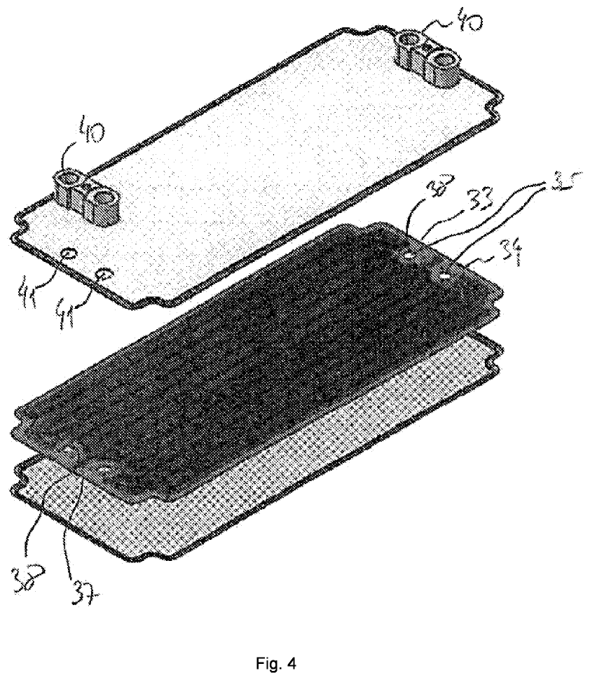

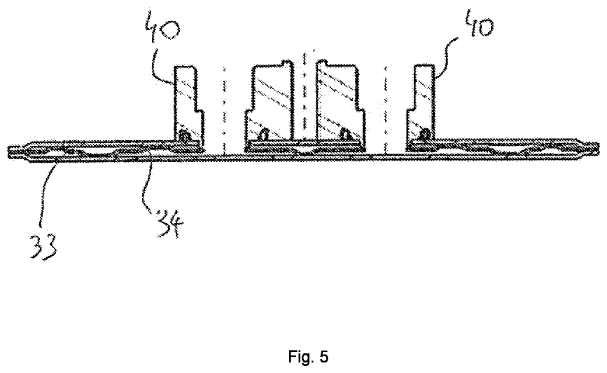

The thermal regulation device 10 has a first external plate 11 and a second external plate 12, and also a central member (denoted with reference number 13 in FIGS. 1-3 and with 33 in FIGS. 4-5) disposed between the first and second external plates 11 and 12, this central member 13 comprising reliefs 14 arranged to form, with the external plates 11 and 12, two layers 15 and 16 of circulation channels for a heat-transfer fluid, these layers 15 and 16 being on either side of the central member 13, these two layers 15 and 16 having the same heat-transfer fluid circulation direction.

The external plates 11 and 12 each have a face 19 arranged to be in thermal contact respectively with one of the battery cells 2 to be cooled.

Thus, the heat exchanges between the thermal regulation device 10 and the battery cells 2 to be cooled, in particular when this direct contact is over a relatively large surface area, can be optimal.

The reliefs 14 on the central member 13 that form the channels 18 have ribs 20.

The central member 13, in particular by means of the reliefs, is arranged to ensure sufficient mechanical strength to withstand the mechanical stresses associated with the use of the heat-transfer fluid, in particular of a refrigerant. The mechanical strength makes it possible in particular to ensure sealing at 15 bars of pressure of the refrigerant, and resistance to bursting at a pressure of 54 bars of the refrigerant.

The central member 13 has a sheet 22 with corrugations 23 that form the reliefs 14.

These corrugations 23 extend from one edge 25 of the sheet to the other 25.

These reliefs 14 of the sheet 22 are formed by forming or stamping.

This sheet 22 has a substantially rectangular shape.

This sheet 22 is made of aluminum.

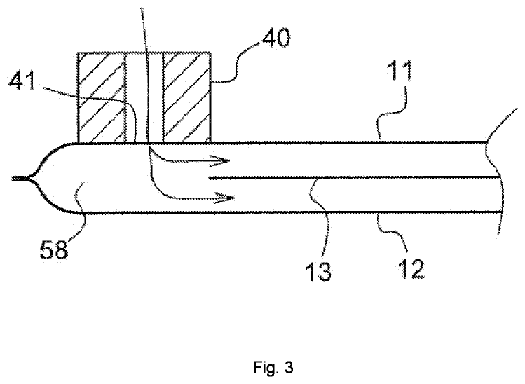

When the central member 13 comprises the corrugated sheet 22, this central member 13 can be shorter than the external plates 11 and 12 in order to allow the creation of two distribution tanks 58 on either side of the central member 13 and facing the connection flanges 40 in order to allow the fluid to supply both layers 15, 16 at the same time, once it has entered the exchanger via said connection flange 40, as is visible in FIG. 3.

Patterns, for example hollows or protrusions 59, are created on the external plates 11 and 12 at these distribution tanks 58 in order to prevent the deformation of the latter under the pressure of the fluid.

In order to create two opposite circulation directions across the width of the thermal regulation device 10, a stamped shape 51 is created on one of the external plates 11, 12 facing the connection flanges 40, and also a specific shape on the central member 13 in order to create two groups of channels in which the fluid can circulate in an opposite direction.

As a variant, as illustrated in FIGS. 4 and 5, the central member 33 has a plate 34.

The reliefs 14 on the plate 34 are formed by stamping.

The plate 34 is made of aluminum material.

The plate 34 forming the central member 33 has two holes 35 on two sides, for passage of heat-transfer fluid over the two layers 15, 16, these holes 35 thus communicating with the two layers 15, 16.

The central member 33 has a fluid separating partition 37 for creating heat-transfer fluid paths within the thermal regulation device 10.

Fluid inlet/outlet zones 38, also called header tanks, in the thermal regulation device 10 and partitions 37 making it possible to create the refrigerant circulation within this thermal regulation device 10 are preferentially created on the central member 33 in order to limit the number of components. The routing within each thermal regulation device 10 ensures uniformity of temperature between each battery cell 2 of one and the same module.

Each thermal regulation device 10 is arranged to cool two battery 2 modules placed against each of these faces 19.

The invention makes it possible to ensure good uniformity between the two faces of the thermal regulation device 10, in other words between the two external plates 11, 12.

These inlet or outlet zones 38 are placed in connection with a connection flange 40 placed on one of the external plates 11 and 12 by means of orifices 41 thus allowing the fluidic connection of the various components.

The thermal regulation device 10 is arranged to be disposed substantially vertically, between two components to be cooled.

The thermal regulation device 10 is arranged to be fastened to the component to be cooled by screwing or by adhesive bonding. Other fastening methods can of course be envisaged.

The brazing of the external plates 11 and 12 of the central member 33 relative to one another makes it possible to create two fluid circulation layers 15, 16 along the height/thickness of the device.

These two layers 15, 16 have the same circulation direction in order to meet the criteria of uniformity of temperature between the various components to be cooled.

In order to create two opposite circulation directions across the width of the thermal regulation device 10, a stamped shape 51 is created on the external plates 11, 12 facing the connection flanges 40, and also a specific shape 52 on the central member in order to create two groups of channels in which the fluid can circulate in an opposite direction. This shape 5 is disposed between the two holes 41.

In the example in FIGS. 4 and 5, the central member 33 comprises holes 35 in order to allow the fluid, once it has entered via the connection flange 40, to be able to circulate or recirculate over the two layers 15, 16. In order to create two opposite circulation directions across the width of the device, a stamped shape 37 is created on one of the external plates 11, 12 facing the connection flanges 40.

In the examples described, the external plates 11 and 12 have internal faces turned toward the central member 13 or 33, these faces being flat over the majority of their surface area.

What is claimed is:

1. A thermal regulation device for an electrical component liable to give off heat during its operation, comprising a first external plate and a second external plate, and a central member disposed between the first and second external plates, the central member including reliefs arranged to form, with the first and second external plates, at least two layers of circulation channels for a heat-transfer fluid, the at least two layers being on either side of the central member, the at least two layers having the same heat-transfer fluid circulation direction.

2. The thermal regulation device as claimed in claim 1, wherein the central member has at least one part arranged to contribute to the formation of a fluid inlet or outlet zone of the thermal regulation device.

3. The thermal regulation device as claimed in claim 1, wherein the central member has a sheet with corrugations that form the reliefs.

4. The thermal regulation device as claimed in claim 3, wherein the corrugations extend from one edge of the sheet to the other.

5. The thermal regulation device as claimed in claim 1, wherein the central member is formed by a plate.

6. The thermal regulation device as claimed in claim 5, wherein the reliefs are located on the plate and are formed by stamping.

7. The thermal regulation device as claimed in claim 5, wherein the plate forming the central member has at least one hole for passage of heat-transfer fluid over the at least two layers, the at least one hole thus communicating with the at least two layers.

8. The thermal regulation device as claimed in claim 1, wherein the central member has at least one fluid separating partition for creating heat-transfer fluid paths within the thermal regulation device.

9. The thermal regulation device as claimed in claim 2, wherein the central member has at least one fluid separating partition for creating heat-transfer fluid paths within the thermal regulation device, wherein the fluid inlet or outlet zones and the at least one fluid separating partition are created on the central member.

10. A system comprising
battery cells to be cooled and
at least one thermal regulation device for an electrical component liable to give off heat during its operation, including a first external plate and a second external plate, and a central member disposed between the first and second external plates, the central member including reliefs arranged to form, with the first and second external plates, at least two layers of circulation channels for a heat-transfer fluid, the at least two layers being on either side of the central member, the at least two layers having the same heat-transfer fluid circulation direction, for cooling these cells.

11. The thermal regulation device as claimed in claim 1, wherein the central member has at least one part arranged to contribute to the formation of a fluid inlet and outlet zone of the thermal regulation device, the fluid inlet and outlet zone being dedicated to a fluid circuit that groups together a plurality of thermal regulation devices that are connected to each other so as to cool a battery pack.
